(19) United States
(12) Patent Application Publication
(10) Pub. No.: US 2009/0253423 A1
(43) Pub. Date: Oct. 8, 2009

(54) Means and Method to Monitor, Collect, Save, Transmit and Evaluate Data Relating to the Use of Electronic Communication Devices to Control Device Use

(76) Inventor: Richard Kullberg, Dunkirk, NY (US)

Correspondence Address: PATRICIA M. COSTANZO;PATS PENDING, P.O. BOX 101, ELMA, NY, 14059, US

(21) Appl. No.: 12/417,879

(22) Filed: Apr. 3, 2009

Related U.S. Application Data
(60) Provisional application No. 61/123,223, filed on Apr. 7, 2008.
(60) Provisional application No. 61/077,982, filed on Jul. 24, 2008.

(51) Int. Cl. H04M 3/00; H04W 24/00

(52) U.S. Cl. 455/419; 455/456.3

(57) ABSTRACT

An electronic communication device, such as a cellphone (including, but not limited to PDA's, I-PODs, BLACKBERRYs, PALMs), is programmed to use GPS, and/or a cell tower triangulation signal, collected data to monitor device motion, or lack of motion, for the purpose of controlling (e.g., stopping, starting, changing, adjusting) use of the device or any device option, saving and transmitting all collected data, including dates and times of any changes and/or adjustments, to a third-party (e.g., police, school officials, insurance agents, etc.) for viewing, processing, and/or storing. Any feature the device offers (including, but not limited to, making or receiving voice or data phone calls, text messaging, video, camera, picture viewer, game, navigation, music, MP3 players, speaker, Windows Professional, Internet Explorer, spreadsheets, BlueTooth and/or any sound, pitch, tone, vibration, or volume for hearing or feeling the device ring to recognize the cell phone was in use is controllable by this technology.

### CROSS-REFERENCE TO RELATED APPLICATIONS

This Application claims benefit of Provisional Application No. 61/123,223, filed Apr. 7, 2008 and Provisional Application No. 61/077,982, filed Jul. 24, 2008.

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISK APPENDIX

Not Applicable

### BACKGROUND

The present invention relates generally to electronic communication devices, and more particularly to a text messaging device that is tied to a software program that provides for long distance control of the device when desired, thus transforming the device into a different state, and yet more particularly to at least one device and programming system providing for control of the electronic communication device and/or desired functions of the device including blocking the use of electronic communication devices in a moving vehicle.

The background information discussed below is presented to better illustrate usefulness of the novelty and present invention. This background information is not admitted prior art.

Text messaging is growing rapidly as the preferred form of communication. In fact, one could say, the use of text messaging has become a raging phenomenon. About 5 billion text messages are sent a month in the United States. This is up from 2.8 billion a year ago, reports the wireless trade association CTIA. This may not be surprising considering that ninety percent of the 192 million active mobile phones in this country are text-capable. People, especially younger people between the ages of 13 and 34 use text message for most of their communication needs, from ordering merchandise, to chatting with friends and family, and even as a way to end a relationship. Teenagers use text messaging as their routine way to communicate. About 63 percent of Americans ages 18 to 27 text message, according to a Pew Internet & American Life Project survey out in March. And a recent study stated that 31 percent of cell phone owners ages 28 to 39 use their phone's texting features, and 18 percent of those 40 to 49 also do. Texting is becoming ubiquitous. Both rock stars and sports teams are now using Texting to bond with fans. Hair salons use it to remind customers of appointments. Users may even receive traffic updates and local weather via texting.

### SUMMARY

As a father of teenagers who use cellular telephones and who drive, the present inventor was dismayed by reports from the Center for Disease Control (CDC) In 2007 that motor vehicle crashes are the leading cause of death for U.S. teens, accounting for 36% of all deaths in this age group. In fact, per mile driven, teen drivers, ages 16 to 19, are four times more likely than older drivers to crash. Moreover, it has been realized that text messaging while driving, or using devices such as a cellphone, BlackBerry, or GPS systems, is becoming a leading factor in accidents across the nation, and is now thought to be one of the leading contributors to a large number of teen, as well as adult, driving accident injuries and fatalities. Adding to the problem is the fact that there seems to be no end to the exponential growth of text messaging. During 2007 there was 80 billion dollars worth of revenues from mobile phone text messaging, which is greater than the sum of all of Hollywood movie box office worldwide revenues, all global music industry revenues, and all global video-game revenues. Text messaging has already made e-mail communication appear to be passe. Text messages reach three billion mobile phones, which is twice the number of people that can be reached via television, and almost three times as many that can be reached via the Internet. Besides teens, senior citizens and young children are text messaging. About 2.8 trillion text messages were sent during 2007 worldwide, which translates to eight billion text messages per day, or 92,000 text messages sent every second (TomiAhonen Consulting 21 Sep. 2007).

Continued research by the inventor found that simulation study at the Monash University Accident Research Center provided strong evidence that retrieving and, in particular, sending text messages has a detrimental effect on a number of critical driving measures. Specifically, negative effects were seen in a driver's ability to detect and respond correctly to road signs, detect hazards, time spent with eyes off the road, and (only for sending text messages) lateral positioning. A separate, yet unreleased simulation study at the University of Utah found a six-fold increase in distraction-related accidents when text messaging. A 2003 study by the Société de l'assurance automobile du Quebec analyzing data collected from 36,078 drivers found that the overall relative risk of having an accident for cellphone users when compared to non-cellphone users averaged 1.38. A 1997 Canadian study and a 2005 Australian study both estimated the risk of a collision while using a cellular telephone was four times greater than the risk when a cellular telephone was not being used. Moreover, it is believed that text messaging is addictive. If this is true, we can expect the number of vehicle accidents that result from text messaging to rise in direct proportion to the increase of number of text messages sent.

Importantly, both studies found that hands-free devices were not markedly safer than hand-held devices. This finding is supported by studies conducted by both the Canadian Automobile Association and the University of Illinois, which found response time while using both hands-free and hand-held phones to be approximately 0.5 standard deviations higher than normal driving (i.e., an average driver, while talking on a cellphone, has response times of a driver in roughly the 40th percentile). Driving using a hands-free device is not safer than driving using a hand-held cellphone, as concluded by case-crossover, epidemiological, simulation, and meta-analysis studies. The increased “cognitive workload” involved in holding a conversation, not the use of hands, causes the increased risk. The consistency of increased crash risk between hands-free and hand held cellphone use is at odds with legislation in many locations that prohibits hand held cellphone use but allows hands-free. Dialing a cellphone is more distracting than talking on a cellphone and hands-free devices that offer voice-dialing may reduce or eliminate that increased risk.

Accidents involving a driver being distracted by talking on a mobile phone and/or text messaging have begun to be prosecuted as negligence similar to driving while intoxicated. In the United Kingdom, from 27 Feb. 2007, motorists convicted of using a hand-held mobile phone while driving have three penalty points added to their license in addition to a fine of £60.

At the time of this writing, four states are actively attempting to ban text messaging while driving. Washington State now bans all drivers from sending electronic messages while driving. In California, Colorado, Connecticut, Delaware, District of Columbia, Illinois, Maine, Maryland, Minnesota, Nebraska, New Jersey, North Carolina, Oregon, Rhode Island, Tennessee, Texas, Virginia, and West Virginia, young or inexperienced drivers are banned from using cellphones, even using a hands-free kit, emergency calls exempted. Also on Jul. 1, 2008 a law prohibiting all drivers from using a handheld wireless telephone while operating a motor vehicle in California went into effect. (Vehicle Code (VC) §23123). Motorists 18 and over may use a hands-free device. Drivers under the age of 18 may NOT use a wireless telephone or hands-free device while operating a motor vehicle (VC §23124).

These measures are responding to many studies that suggest text messaging while driving is a growing danger. It has been reported that about 46 percent of drivers between the ages of 16 to 17 text message while driving. One Nationwide Insurance study suggests that text messaging while driving is age related, with 37 percent of people age 18 to 27 text messaging while driving, while just 14 percent of those ages 28 to 44 and two percent of drivers ages 45 to 60 admitted to it. Insurance companies often advise drivers to avoid text messaging while driving to avoid costly damages or, in the worst case, a loss of life.

Sadly, current laws banning cellphone use in New York and Connecticut, however, have proven to be ineffective, due in part to a lack of effective enforcement. The percentage of offenders decreased from 2.3% to 1.1% immediately after the laws were put into place, but after being in effect for a year the percentage of offenders increased to 2.1%, which is not significantly different from the pre-law figure.

Some industry attempts to address the dangers presented by text messaging while driving includes the efforts of Virtual Management, Inc. who developed the EVA (Electronic Virtual Assistant), a live transcribing service that sends and receives e-mail or text messages via voice mail. The system reads e-mails or text messages back to you from a hands-free device. This live transcribing service takes the typing out of text messaging and is also supposed to save businesses, and their workers, money through tax write-offs and expense accounting. The EVA system identifies a user's list of e-mail addresses and automatically forwards all incoming e-mails and text messages as a voice message to a user's cellphone so that users can safely listen to them on a hands-free car kit. This system also allows a user to initiate a communication by dictating a message that gets sent as an e-mail. While this use of voice recognition technology is advertised to be highly safe while driving, even the proponents of the hands-free messaging system warn that drivers are always advised to pull over to the side of the road if use of a mobile device is required.

Thus, the inventor recognized that there is no way to safely drive a vehicle while text messaging or orally sending electronic messages using any type of electronic communication device.

Accordingly, the present inventor solved the problem of persistent and uncontrollable text messaging while driving by providing for an electronic communication device in communication with a software problem that is used in conjunction with and without the cellular device to control the use of the phone when desired by providing for a device, comprising:

an electronic communication device and a software program tied to the electronic communication device providing for long distance control of the use of the electronic communication device when desired to transform the device into a different state that further comprises a blocking mechanism for preventing a user's electronic communication device from receiving or sending electronic communications while the electronic communication device when desired.

The blocking mechanism comprises:

an electronic communication device providing for sending or receiving electronic communications,
and

a computer programmed for monitoring and transmitting speed data of the motion of the electronic communication device, the computer being in electronic communication with the electronic communication device,

a computer programmed for receiving the transmitting speed data for blocking the use of the electronic communication device while the electronic communication device is in motion as a result of being transported by the vehicle, the computer being in electronic communication with the electronic communication device.

The inventor further provided a system for preventing a user's electronic communication device from receiving or sending electronic communications while the electronic communication device is in a predetermined state of motion, comprising:

providing for an electronic communication device for sending or receiving electronic communications,
and

providing for a computer program that monitors and transmits speed data of the motion of the electronic communication device, the computer being in electronic communication with the electronic communication device, and

providing for a computer program for receiving the transmitted speed data where the computer program provides for blocking the use of the electronic communication device when in a state of predetermined motion, the computer program being in electronic communication with the electronic communication device, where in the electronic communication device is a cellular device.

Additionally, the system provides for preventing the cellular device from receiving or sending electronic communications while in a predetermined state of motion by:

providing a cellular device capable of sending or receiving electronic communications,
and

providing for at least a global positioning system and/or at least an electronic speed adaptation system programmed for monitoring the speed of the motion of the cellular device,
the positioning system and/or the adaptation system being a working part of the cellular device's electronic system,
the positioning system and/or the adaptation system programmed for blocking a user from using the cellular device while it is in a predetermined state of motion.

Furthermore, the inventor provides an electronic speed adaptation system for monitoring the speed of the cellular device further comprises a GPS that is a working part of and in communication with the cellular device's electronic system, the electronic speed adaptation system contained within the GPS, where the system further comprises a cellular device function control program for use with a programmable device which relies on a GPS transmission signal location system or has a built-in GPS system location system and/or providing on cell tower triangulation systems to determine the predetermine rate of motion, of the cellular device, comprising the steps of:

providing for a cellular device function control program,

having the cellular device positioning program determine the location and the motion of the cellular device to determine if the cellular device or any of its functions should be enabled or disabled,

storing data resulting from the determination of the location and motion in a storage device,

evaluating the status of the cellular device based on the stored data,

enabling or disabling any one or all desired cellular device functions to achieve a desired effect based on the status of the cellular device.

Additionally, the cellular device function control program may be stored in the cellular device and provides for the history of determined data is transmitted to and shared with a third party. Further, where the enabling or disabling any desired cellular device function is accomplished by the program and the program is shared between the cellular device and the third party so that the third-party may view, process, and/or store the data. The data may include dates, times and locations of the unit when the cellular device was adjusted by the programmable device within it.

The system also provides for a blocking device for preventing a user's electronic communication device from receiving or sending electronic communications while the electronic communication device is in a predetermined state of motion, the blocking device comprising:

an electronic communication device for sending or receiving electronic communications,
and

a computer programmed for monitoring and transmitting speed data of the motion of the electronic communication device, the computer being in electronic communication with the electronic communication device,

a computer programmed for receiving the transmitting speed data for blocking the use of the electronic communication device, the computer being in electronic communication with the electronic communication device.

### BRIEF DESCRIPTION OF THE DRAWINGS

In order that these and other objects, features, and advantages of the present invention may be more fully comprehended and appreciated, the invention will now be described with reference to specific exemplar embodiments, which are illustrated in appended drawings, wherein like reference characters indicate like parts throughout the several figures. It should be understood that these drawings only depict preferred embodiments of the present invention and are therefore not to be considered limiting in scope. Accordingly, the manner of making and using the present invention will be described with additional specificity and detail through the use of the accompanying drawings, in which:

FIG. 1 illustrates a perspective diagrammatic sketch view of an electronic communication device having means for controlling transmission (sending or receiving) of electronic communication, such as controlling text messaging in a moving vehicle, according to the principles of the present invention.

FIG. 2 illustrates a flow chart illustrating a system used to block transmission of electronic communication by an electronic communication device, such as using a cellular telephone for text messaging in a moving vehicle, according to the principles of the present invention.

### REFERENCE CHARACTERS AND PARTS TO WHICH THEY REFER

2 Computer chip with program internal to cellphone 10.
10 An exemplary electronic communication device, e.g., a cellphone.
12 A global positioning system (GPS) in communication with cellphone 10.
14 An intelligent speed adaptation (ISA) in communication with cellphone 10.

### DEFINITIONS

Cellular device, as used herein, includes but is not limited to cellphones, PDAs, i-Pod (brand name), BlackBerry (brand name), Palm (brand name), hand-held cellular devices, and/or any cellular device used to perform the same or similar functions of a cellphone.
Cellphone functions, as used herein, include but are not limited to, calling out or receiving of all phone voice and data features, text messaging, E-mails, video, camera operation, picture viewer, games, navigation activities, music, MP3 player applications, Internet access, GOOGLE, and other search engine searches, spreadsheet applications, appointment managers, and/or any sound, pitch, tone, vibrations, or volume allowing a person to hear or feel the cell device ring or in any way be able to recognize that the cellphone was in use with respect to any or all of its operations.
Global Positioning System (GPS), as used herein, refers to the Global Navigation Satellite Systems. Utilizing at least 24 medium Earth orbit satellites that transmit precise microwave signals, the system enables a GPS receiver to determine its location, speed, and direction at a particular (recorded) time. The capacity to determine relative movement enables a receiver to calculate local velocity and orientation, useful in vessels, such as moving automobiles, boats, airplanes, trucks, trains, or the like.
Intelligent Speed Adaptation (ISA), as used herein, refers to any system that is able to monitor both the local speed limit and the vehicle speed. An ISA is able to warn a driver when the vehicle is found to be exceeding the speed limit or can automatically reduce the vehicle's speed. Intelligent speed adaptation uses information about the area through which the vehicle travels to make decisions about what the correct maximum speed should be. Intelligent systems know when the vehicle has entered a new speed zone, such as where variable speed zones are in force (e.g. school zones), and can be configured to work with temporary speed zones (such as at accident scenes or near road work sites). The purpose of ISA is to assist the driver in keeping to the lawful speed limit at all times.
Mobile phone or simply “mobile” or cellphone, as used herein, refers to a wireless electronic device used for long-range mobile communication using a network of specialized base stations known as cell sites. In addition, current cellphones may support many additional services and accessories, such as SMS (Short Message Service) for text messaging, GPS (Global Positioning System), email, packet switching for access to the Internet, and MMS (Multimedia Messaging Service) for sending and receiving photos and video. Most current mobile phones connect to a cellular network of base stations which is in turn interconnected to the public switched telephone network (PSTN) with the exception being satellite phones.
Triangulation, as used herein, refers to a process of finding coordinates and distance to a point by calculating the length of one side of a triangle, given measurements of angles and sides of the triangle formed by that point and two other known reference points, using the law of sines. Triangulation is used for many purposes, including surveying, navigation, metrology, astrometry, binocular vision, model rocketry, and gun direction of weapons. Many of these surveying problems involve the solution of large meshes of triangles, with hundreds or even thousands of observations. Complex triangulation problems involving real-world observations with errors require the solution of large systems of simultaneous equations to generate solutions.
Vehicle, as used herein, is defined as any type of means of transportation, including, but not limited to an automobile, motorcycle, truck, bus, train, plane, or boat.
Velocity, as used herein, is defined as the rate of change of position of an object, such as a vehicle. It is a vector physical quantity; both speed and direction are required to define it. In the SI (Standard System of Units metric) system, it is measured in meters per second (m/s) or ms⁻¹. The scalar absolute value (magnitude) of velocity is speed. For example, “5 meters per second” is a scalar and not a vector, whereas “5 meters per second east” is a vector.

It should be understood that the drawings are not necessarily to scale. In certain instances, details which are not necessary for an understanding of the present invention or which render other details difficult to perceive may have been omitted.

### DETAILED DESCRIPTION

It should be noted that in addition to the described and illustrated embodiments, the disclosed invention is disposed to a plurality of embodiments in various uses, method steps, sizes, shapes, and forms. For example, the cellphone shut-off device according to the principles of the present invention could be used to provide a shut-off means for any device or machine, not just for a messaging device, such as a cellphone. Alternatively, the present invention could be used to provide a start-up, i.e., turn-on, instead of a stop, for a device. Therefore, it is to be understood that the embodiments described herein are provided with the understanding that the present disclosure is intended as illustrative and is not intended to limit the invention to the embodiments described herein.

The present invention is designed to reduce or eliminate the number of accidents that occur due to a driver text messaging, dialing, or talking on a cellphone, or a similar device, such as a BlackBerry, in a vehicle that is in motion. As was discussed above, the inventor has recognized that even when it is illegal to use cellphones, text messaging devices, and the like in a moving vehicle, the desired effect of reducing or eliminating accidents is not being achieved. Likewise, the use of hands-free communication devices is not having the desired safety effect, in part, because of the distractions caused when receiving and/or sending a voice message.

Accordingly, the principles of the present invention put forward means and methods to completely control the use of any electronic communication device. One favored embodiment prohibits the use of a cellphone, or any other means of electronic communication, such as sending or receiving text messages or voice mail in a vehicle in motion (with the exception of emergency calls, such as calling 911). The invention relies on at least one computer that monitors the speed at which an electronic communication device, such as a cellphone, is traveling when in a moving vehicle. Such a computer could be a GPS (Global Position System) and/or an ISA (Intelligent Speed Adaptation) system. These types of computers are usually, but not required to be by the invention, pre-installed into today's electronic communication devices, such as cellphones. The computers that monitor and control the use of the electronic communication device may be installed within or without the device, as desired. The communication device could be either a carry-about, or one that is installed within a vehicle. It should be noted that the present invention resides not in any particular computer, electronic communication device, moving vehicle, positioning system, stationary situation, or software program, but rather in the unique physical or logical structure of any one or more of the above-mentioned computer, electronic communication device, moving vehicle, stationary situation, positioning system, or software program and how each is communicatively connected to and interacts with, physically or logically, with the other(s) through the software and/or hardware program according to the principles of the present invention to monitor, collect, save, and transmit data on the use of the electronic communication device for the purpose of controlling the device or desired functions of the device, as herein disclosed that distinguishes the principles of the present invention.

Most cellphones come equipped with a complete navigation system, such as a GPS, that typically uses data collected from a system of satellites to locate an electronic communication device user on, for example, a road, if the vehicle is a road drivable vehicle using the unit's map database. Using the map database, the unit can give the driver directions to other locations along roads also in its database. Dead reckoning using distance data from sensors attached to the drivetrain, a gyroscope, and/or an accelerometer can be used for greater reliability, as it is possible for GPS signal loss to occur. This type of data collection and processing of the collected data means that the geographic location and the motion of any vehicle possessing such a positioning navigation system can be determined not only by the driver of the vehicle, but by outside monitoring systems. This information and the time involved in traveling from one monitored site to another provides such devices with the ability to determine the speed the vehicle is traveling. There are four types of technology currently available for determining local speed limits and determining the speed of the vehicle (independent of the vehicle's own speedometer). Besides a GPS, there are Radio Beacons, Optical recognition, and Dead Reckoning systems.

Additionally, there are systems known as Intelligent Speed Adaptation (ISA) systems. These systems are programmed to not only monitor the local speed limit and the vehicle speed, but further to implement a reaction when the vehicle exceeds the speed limit. There are two types of speed adaptation systems, passive and active, the basic difference being that passive systems simply warn the driver of excess speed whereas active systems automatically correct the vehicle's speed. Intelligent speed adaptation uses information about the area through which the vehicle travels to make decisions about what the legal speed limit is. The purpose of ISA is to assist the driver in keeping within the lawful speed limit at all times, particularly as the vehicle passes through different speed zones.

The present invention integrates systems such as GPS, ISA, and electronic messaging systems to provide a means and method of allowing drivers to use, or preventing drivers from using (sending or receiving), electronic messaging systems when the vehicle they are driving has a positive velocity, if, for example, the vehicle's velocity is over 5 mph. The 5 mph is a suggested rate of speed because if a cellphone user were walking or running, they would not want their cellphone to be deactivated. The miles per hour limit may be varied according to requirement. A cellphone's GPS tracks the speed of the phone as it is being transported and provides this data to the ISA system to provide the Temporary Text and Cellphone Shut-Off System of the present invention. When the speed adaptation system recognizes that the device is in motion, it checks to see if any form of electronic messaging system is being employed. If an electronic messaging system is being used while the vehicle is in motion, the electronic messaging system is temporarily closed down. During a temporary close-down stage, all cell and text messages are saved as if the phone were in an ordinary shut-off position. The present system can be programmed to immediately send back a text message to notify the sender that the text or voice message they have just sent has been received, but not yet read or heard and will be stored in the recipients memory until read. The sender will see the letters “CIM” (cell in motion) making the sender aware the final text/voice message has been delivered but not yet retrieved. If preferred, the speed adaptation system can be set to automatically deactivate all electronic messaging systems whenever it senses that the communication device is in motion over a certain speed. If desired, a telephone company could be allowed to prohibit all device users in a given area from text message use. For example, if New York State made text messaging in a moving vehicle illegal, a company offering cellphone service in New York State could be allowed to automatically prohibit all cellphone use when it detected its cellphone to be in a moving vehicle. The system could also be programmed to keep police, fire, doctors, and emergencies vehicles, etc. from being limited by the system. This cellphone service provider shut-off ability could also be used only on request, such as when a parent recognizes that their driving youngster is using a cellphone while driving against parental restrictions. Thus, the ability to monitor and control cellphone use could reside either in a cellphone's hardware and/or software or with a cellphone provider.

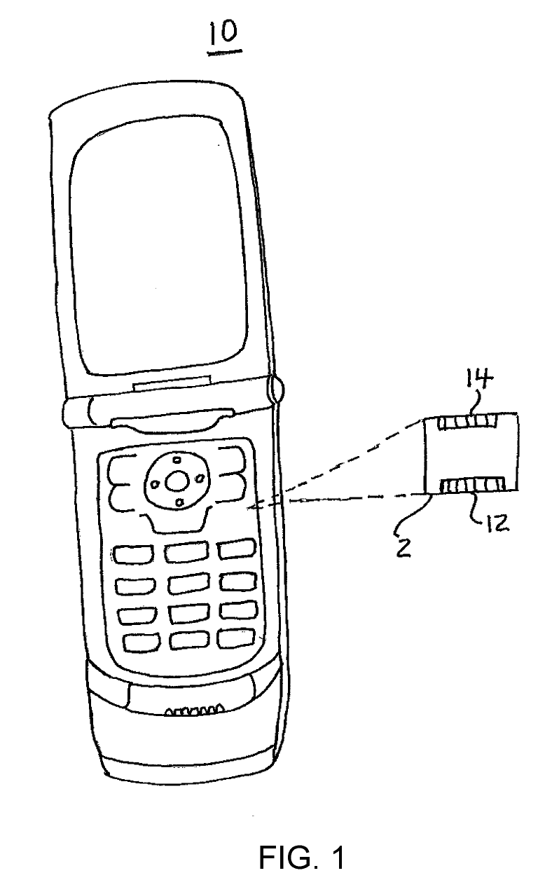

FIG. 1, a perspective diagrammatic sketch, illustrates one preferred embodiment with a means for monitoring use of an electronic communication device, collecting related data, and blocking transmission, whether sending or receiving, of electronic communications. The exemplary means used to illustrate such a communication device in FIG. 1 is cellphone 10. One example of transmitting an electronic communication is the sending or receiving a of text message while the transmitter cellphone is in a moving vehicle. Cellphone 10, according to the principles of the present invention, has as part of its electronics chip 2, which at minimum has at least an ISA (Intelligent Speed Adaptation) 14 and/or GPS (Global Positioning System) 12 that is programmed not only to monitor the position and rate of motion of the phone, collect and save the monitored data, but also to act as a transmission blocking means according to the principles of the present invention. Because of the ability of both an ISA and GPS, the transmission blocking means may reside in the ISA, the GPS, or in a combination of both. In many instances an ISA system is electronically embedded within a GPS, but need not be as it may be programmed on a chip separate from the chip holding the GPS. Alternatively, the device can be programmed electronically by the phone company without having to physically bring the phone in to install a chip. Such known electronic details do not affect the principles of the present invention. It also should be understood that electronic communication includes voice transmission, text messaging, video transmission, and any other means that are used as electronic communication means. Cellphone 10, may or may not support a full compliment of services, such as SMS (Short Message Service) for text messaging, GPS (Global Positioning System), ISA (Intelligent Speed Adaptation), email, packet switching for access to the Internet, and MMS (Multimedia Messaging Service) for sending and receiving photos and video. The present invention, ie., the system that provides for the blocking means which here reside in both GPS 12 and ISA 14, is illustrated as part of the cellphone's electronics and is programmed to monitor and record the velocity and/or speed of the cellphone as it is transported by a vehicle. It should be understood, however, that it is within the conception of the present invention that the blocking system could physically reside within the electronics of the vehicle. In this case the blocking system would be programmed to recognize the use of a cellphone within the vehicle. This would prohibit transmission even if the transmitting device was not equipped with a GPS or the like, or if the user had a way of turning off the GPS while transmission was taking place. ISA 14 of the present invention is programmed to block or shut-down any electronic transmission that is being conducted when the GPS informs the ISA that the vehicle is in motion. The ISA can be set to provide either a blocking action against the messaging function, or a temporary shut-off action of the messaging function, preventing messaging or other communication to be transmitted or received while the vehicle is in motion. In either case, if messages arrive while they are blocked or if the cellphone is in a temporary shut-off mode, the incoming messages will be saved in the same manner as they would when one's cellphone is turned off, for example. Moreover, the ISA and/or GPS can be set to determine that “in motion” means any positive value of speed or that “in motion” means that whenever the speed of the vehicle is greater than a certain value, such as 5 mph, it will act to prevent communication transmission. The reason for having a minimum speed that is greater than zero is to allow use of the transmitting device while a user is walking.

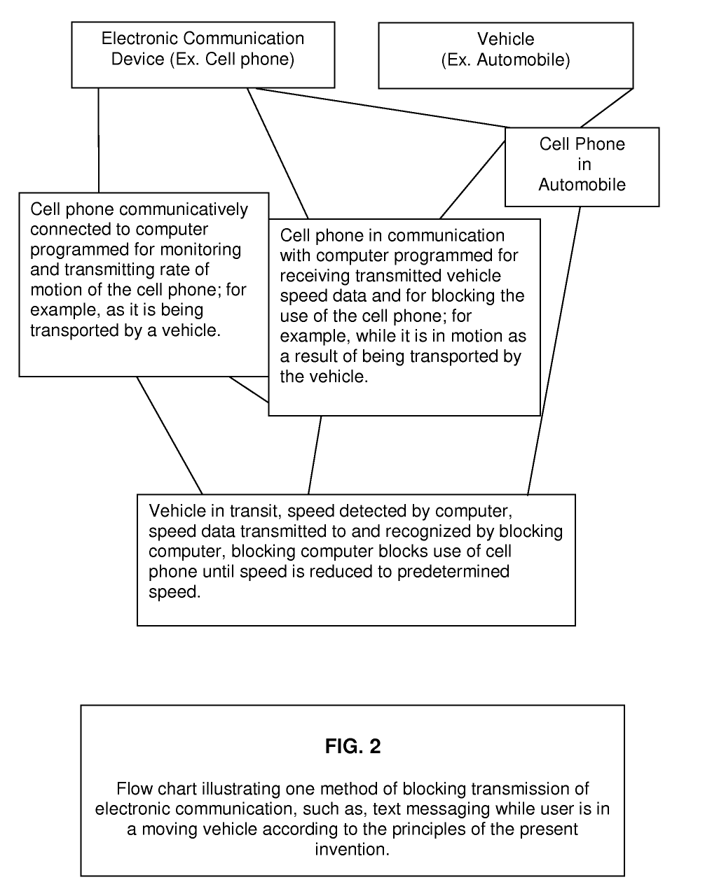

FIG. 2, a flow chart, illustrates a method for blocking transmission of electronic communication, such as, text messaging in a moving vehicle according to the principles of the present invention. FIG. 2 illustrates in diagrammatic form a user's electronic communication device, which in this illustration takes the form of a cellphone. The figure also illustrates a vehicle which takes the form of an automobile. The diagram illustrates that the cellphone is provided with a computer programmed for monitoring and transmitting speed data of the movement of the electronic communication device as a result of its being transported by a vehicle and that this computer is in electronic communication with a computer programmed for receiving the transmitted speed data. If the vehicle starts to move and if the speed of the cellphone (vehicle) is monitored at greater than 5 mph, for example the computer will automatically block the use of the electronic communication device.

If desired, there can be an override, with restrictions. For example, passengers on a train may use their traveling hours for business purposes and would expect to be able to contact their business associates. Or, if there are passengers on a road trip, and they need to contact someone. In such cases, and with certain qualifications, a passenger in a vehicle could, for example, text message a code to their cell carrier with the driver's cell number and perhaps their driver's license number, if for instance there was an age qualifier on a user's ability to initiate an override. There are many ways an override could be initiated and a variety of restrictions could be placed on a user's ability to obtain an override.

Moreover, the invention contemplates a program for use with a programmable device which relies on a GPS transmission signal or has a GPS system within a cellular device and/or cell tower triangulation systems to determine the rate of movement, or non-movement, of the cellular device. Once this determination is made, a cellphone-function-control program designed to enable or disable any desired cellular device function becomes activated to achieve the desired effect. This program may be stored within the cellphone or may exist external to the cellphone. A determination history and any adjustments made to the device by the program may be, as desired, transmitted to third-party subscriber(s) for viewing, processing, and/or storage. The information transmitted may include dates, times and locations of the unit when the cellular device was adjusted by the programmable device within it. The third-party subscribers may include insurance companies, law enforcement agencies, parents, and so on. The cellphone functions could include text-messaging, calling out, receiving messages, etc.

### EXAMPLE 1

Monitoring Vehicle/Cellphone Motion. In the operation of an automobile, truck, bus, taxi, boat, or air plane when the vehicle is in motion the cellular device is effectively moving at the same speed as the vehicle. The GPS signal emanating from the cellular device will indicate to a designated third party the speed the vehicle and device are traveling. The cellphone-function-control program may then be used to shut-off, turn-on, and/or place on standby any or all of the desired cellphone functions, and/or may enable identification of the cellphone owner (with appropriate consequences in case the vehicle in which the device was carried has exceeded speed limits in the area through which it was traveling). All of these options are available either under direct real-time control by the third party or, alternatively, may be reported periodically to a mainframe computer or desktop server for inclusion into a database from which data reports may be compiled for later delivery to a third party.

### EXAMPLE 2

Monitoring Vehicle/Cellphone Non-motion. The combination of (1) the location of the cellular device within, or outside of, a certain programmed area (i.e., a school, hospital, or selected office locations) and (2) non-movement of the cellular device (because its user is sitting at a desk) sends a signal to the cellphone-function-control program that the cellular device is not in motion in the designated area indicating that the student or office worker is either in class or working at his or her desk, respectively. So in these situations, the cellphone-function-control program may be designed to block the use of the cellular device for text messaging, playing music, and game playing. The device, however, may still allow access to other functions of the device, such as incoming or outgoing voice calls in and internet access. Once the person leaves their desk and begins to walk at a speed that has been selected to indicate that the student has left class or the worker has left his or her work station, or once the person is beyond the programmed area, in which restrictions of the use of certain functions of the cellular device are imposed, the use of the functions that were blocked, return to use-mode. Any messages received while the device was on standby would be stored in the same manner as if the cellular device had been shut-off and may be retrieved when the blocking action is removed. It should be appreciated that any combination of cellular device functions can be turned on, off or placed on standby.

It should be noted that the present invention resides not in any one of the disclosed features per se, but rather in the particular and novel structure of the components and the novel combinations of the features herein disclosed which distinguish the present invention. Considering the enormous need for the present invention, the life and death issues that use of the invention can mitigate, and considering the cost in terms of time and money, and the great amount of money and legislative effort that has been, and still is being, spent to find a solution for the large number of injuries and deaths caused by drivers text messaging in moving vehicles, and similarly the great amount of money and effort by educators and employers that has been, and still is being, spent to find a solution to students text-messaging within the classroom and employees text-messaging or game-playing at their work-station, this imaginative and distinctive combination of familiar elements yields results that are not obvious and have not been predictable.

What is claimed is:

1. A device, comprising:
an electronic communication device and a software program tied to said electronic communication device providing for long distance control of the use of the electronic communication device when desired to transform the device into a different state.

2. The device, as recited in claim 1, further comprising a blocking mechanism for preventing a user's electronic communication device from receiving or sending electronic communications while the electronic communication device when desired.

3. The device, as recited in claim 2, wherein said blocking mechanism for preventing a user's electronic communication device from receiving or sending electronic communications while the electronic communication device when desired, further comprises:
an electronic communication device providing for sending or receiving electronic communications,
and
a computer programmed for monitoring and transmitting speed data of the motion of the electronic communication device, said computer being in electronic communication with said electronic communication device,
a computer programmed for receiving said transmitting speed data for blocking the use of said electronic communication device while the electronic communication device is in motion as a result of being transported by the vehicle, said computer being in electronic communication with said electronic communication device.

4. A system for preventing a user's electronic communication device from receiving or sending electronic communications while the electronic communication device is in a predetermined state of motion, comprising:
providing for an electronic communication device for sending or receiving electronic communications,
and
providing for a computer program that monitors and transmits speed data of the motion of the electronic communication device, said computer being in electronic communication with said electronic communication device, and
providing for a computer program for receiving said transmitted speed data where said computer program provides for blocking the use of said electronic communication device when in a state of predetermined motion, said computer program being in electronic communication with said electronic communication device.

5. The system, as recited in claim 4, further comprising where in said electronic communication device is a cellular device, and a method for preventing said cellular device from receiving or sending electronic communications while in a predetermined state of motion, comprising;
providing a cellular device capable of sending or receiving electronic communications,
and
providing for at least a global positioning system and/or at least an electronic speed adaptation system programmed for monitoring the speed of the motion of the cellular device,
said positioning system and/or said adaptation system being a working part of the cellular device's electronic system,
said positioning system and/or said adaptation system programmed for blocking a user from using said cellular device while it is in a predetermined state of motion.

6. The system, as recited in claim 5, where at least an electronic speed adaptation system for monitoring the speed of the cellular device further comprises a GPS that is a working part of and in communication with the cellular device's electronic system,
said electronic speed adaptation system contained within said GPS.

7. The system, as recited in claim 6, further comprising:
a cellular device function control program for use with a programmable device which relies on a GPS transmission signal location system or has a built-in GPS system location system and/or providing on cell tower triangulation systems to determine the predetermine rate of motion, of the cellular device, comprising the steps of:
providing for a cellular device function control program, having the cellular device positioning program determine the location and the motion of the cellular device to determine if the cellular device or any of its functions should be enabled or disabled,
storing data resulting from the determination of the location and motion in a storage device,
evaluating the status of the cellular device based on the stored data,
enabling or disabling any one or all desired cellular device functions to achieve a desired effect based on the status of the cellular device.

8. The system, as recited in claim 7, wherein the cellular device function control program is stored in the cellular device.

9. The system, as recited in claim 7, wherein the history of determining the data is transmitted to and shared with a third party.

10. The system, as recited in claim 9, wherein the enabling or disabling any desired cellular device function is accomplished by said program that is shared between the cellular device and the third party.

11. The system, as recited in claim 9, wherein the third-party may view, process, and/or store said data.

12. The system, as recited in claim 9, wherein said data may include dates, times and locations of the unit when the cellular device was adjusted by the programmable device within it.

13. The system, as recited in claim 4, further comprising:
providing for a blocking device for preventing a user's electronic communication device from receiving or sending electronic communications while the electronic communication device is in a predetermined state of motion, said blocking device comprising:
an electronic communication device for sending or receiving electronic communications,
and
a computer programmed for monitoring and transmitting speed data of the motion of the electronic communication device, said computer being in electronic communication with said electronic communication device,
a computer programmed for receiving said transmitting speed data for blocking the use of said electronic communication device, said computer being in electronic communication with said electronic communication device.

14. The system, as recited in claim 13, further providing for preventing a user's electronic communication device from receiving or sending electronic communications while the electronic communication device is in motion as a result of being transported within a vehicle, comprising the steps of:
providing for an electronic communication device for sending or receiving electronic communications,
and
providing for a computer programmed for monitoring and transmitting speed data of the motion of the electronic communication device as a result of its being transported by a vehicle, said computer being in electronic communication with said electronic communication device, and
providing for a computer programmed for receiving said transmitting speed data for blocking the use of said electronic communication device while the electronic communication device is in motion as a result of being transported by the vehicle, said computer being in electronic communication with said electronic communication device.

15. The system, as recited in claim 9, further comprising:
a method for preventing a user's cell phone from receiving or sending electronic communications while the user's cell phone is in motion as a result of being transported within a vehicle, comprising the steps of;
providing for an electronic communication device for sending or receiving electronic communications,
said communication device being a working part of a cell phone's electrical system, and
providing for at least a global positioning system and/or at least an electronic speed adaptation system programmed for monitoring the speed of the motion of the electronic communication device as a result of its being transported by a vehicle,
said positioning system and/or said adaptation system being a working part of the cell phone's electronic system,
said positioning system and/or said adaptation system programmed for blocking a user from using said device while the cell phone is in motion as a result of being transported by the vehicle.
